(19) United States
(12) Patent Application Publication
(10) Pub. No.: US 2015/0275070 A1
(43) Pub. Date: Oct. 1, 2015

(54) FRAC BALL AND HYDRAULIC FRACTURING SYSTEM

(71) Applicant: NCS MULTISTAGE INC., Calgary (CA)

(72) Inventors: Don GETZLAF, Calgary (CA); John RAVENSBERGEN, Calgary (CA)

(21) Appl. No.: 14/673,161

(22) Filed: Mar. 30, 2015

Related U.S. Application Data
(60) Provisional application No. 61/971,844, filed on Mar. 28, 2014.

(51) Int. Cl. C09K 8/80

(52) U.S. Cl. CPC C09K 8/805

(57) ABSTRACT

There is provided a fluid communication-interference body, such as a frac ball, for deployment downhole within a wellbore for effecting interference to fluid communication between the wellbore and the subterranean formation. The body may include a shall and an inner core. The shell includes shell material which may include metal-comprising material, such as titanium. The core includes core material. The core material may include composite material such as microspheres distributed within a polymer material-comprising matrix.

### FIELD

The present disclosure related to bodies, deployable by flowing fluids, for landing on corresponding seats within a wellbore, for interfering with fluid communication within the wellbore.

### BACKGROUND

Frac balls, and other deployable bodies, are used for effecting zonal isolation within a wellbore to enable multi-stage fraccing. Such bodies are intended to provide sufficient zonal isolation to enable manipulation of wellbore components, such as sleeves, through pressurization within a selected zone. As well, while having sufficient strength to withstand the applied pressure while providing zonal isolation, it is preferable, in at least some applications, that such bodies are not so dense as to compromise their ability to flow back to the surface.

### SUMMARY

In one aspect, there is provided a fluid communication-interference body comprising: a shell including a shell material having a modulus of elasticity of at least about 15×10⁶ psi, at standard ambient temperature and pressure (“SATP”) conditions (defined as a temperature of 25 degrees Celsius and a pressure of 1 bar), and a tensile strength of at least about 50 ksi (50,000 psi), at SATP conditions; and an inner core including an inner core material having a minimum compressive strength of at least about 5 ksi (5,000 psi), at SATP conditions.

In another aspect, there is provided a fluid communication-interference body comprising: a shell; and an inner core including inner core material, wherein the inner core material includes microspheres.

In yet another aspect, there is provided a fluid communication-interference body comprising: a shell including metal-comprising material; and an inner core including polymer-comprising material; wherein the body is configured for engaging a seat disposed within a wellbore such that, when the fluid communication-interference body is seated against the seat while a pressure differential of greater than 5,000 psi is being applied across the seat and effected by wellbore treatment fluid being supplied uphole relative to the seat, proppant of the wellbore treatment slurry is prevented, or substantially prevented, from being conducted past the fluid communication-interference body, through an orifice, and downhole relative to the seat.

In a further aspect, there is provided a system for effecting production of hydrocarbon material from a subterranean formation, comprising: any one of the fluid communication-interference bodies described above, and a seat, configured for installation within a wellbore, and including an orifice, wherein the fluid communication-interference body is configured for being deployed downhole within a wellbore by being flowed within fluid being supplied to the wellbore, and becoming seated on the seat while the seat is installed within the wellbore such that interference to fluid communication, via the orifice, and across the valve seat, is effected by the seating of the fluid communication-interference body on the valve seat.

In yet a further aspect, there is provided a system for effecting production of hydrocarbon material from a subterranean formation, comprising: any one of the fluid communication-interference bodies described above, and a seat installed within a wellbore, and including an orifice; wherein the fluid communication-interference body is seated on the seat such that interference to fluid communication, via the orifice, and across the valve seat, is effected by the seating of the fluid communication-interference body on the valve seat.

In yet a further aspect, there is provided a method of producing reservoir fluid from a subterranean formation comprising: supplying hydraulic treatment fluid, via a wellbore opening defined within a seat, to the subterranean formation; deploying any one of the the fluid communication-intereference bodies described above within the wellbore such that the fluid communication-interference body becomes seated against the seat such that interference is effected to fluid communication, via the wellbore opening, and across the seat; presurizing the wellbore uphole of the seating of the fluid communication-intereference body against the seat such that a valve is displaced to effect opening of a port; and supplying hydraulic treatment fluid, via the port, to the subterranean formation.

### BRIEF DESCRIPTION OF DRAWINGS

The preferred embodiments will now be described with the following accompanying drawings, in which:

FIG. 1 is a schematic illustration of an embodiment of a fluid communication-interference body of the present disclosure;

FIG. 2 is a schematic illustration of a sectional view of the fluid communication-interference body of FIG. 1;

FIG. 3 is a schematic illustration of a system for effecting hydraulic fracturing of a subterranean formation, using the fluid communication-interference body of the present disclosure; and

FIGS. 4 to 7 are schematic illustrations of the stages of a hydraulic fracturing process being implemented within the system illustrated in FIG. 3.

### DETAILED DESCRIPTION

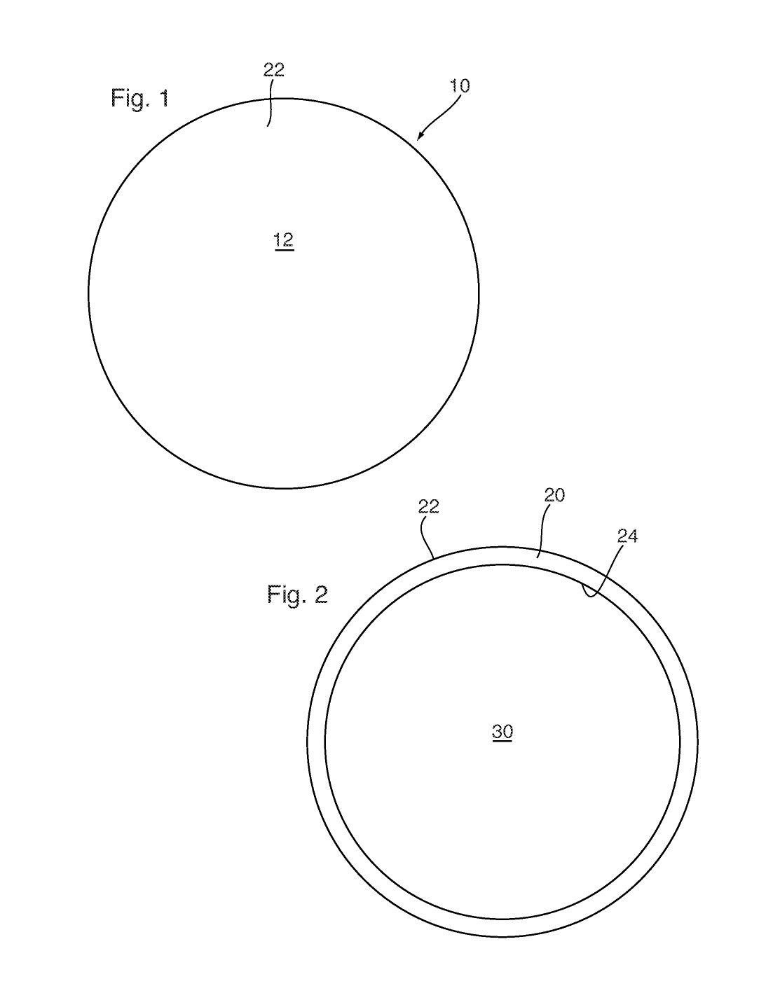

Referring to FIGS. 1 and 2, there is provided a fluid communication-interference body 10 for interfering with fluid communication through an opening within a wellbore.

FIG. 1 is a front view of the fluid communication-interference body 10. FIG. 2 is a sectional view of the fluid communication-interference body 10. In some embodiments, for example, the fluid communication-interference body 10 is in the shape of a ball, however, it is understood that the fluid communication-interference body 10 can take the form of any one of a number of shapes, so long as the shape is conducive for effecting interference with fluid communication through an opening within the wellbore. In some embodiments, for example, the fluid communication-interference body 10 can be a frac ball.

The fluid communication-interference body 10 includes a shell 20 and an inner core 30.

The shell 20 includes an exterior surface 22. In some embodiments, for example, the exterior surface 22 of the shell 20 is continuous or substantially continuous. In some embodiments, for example the exterior surface 22 of the shell 20 is uninterrupted or substantially uninterrupted. In some embodiments, for example, the exterior surface 22 of the shell 20 defines the exterior surface 12 of the fluid communication-interference body 10.

In some embodiments, for example, the shell 20 has a minimum thickness of at least about 0.5 millimetres.

In some embodiments, for example, the shell 20 has a minimum thickness of less than about 2 millimetres

In some embodiments, for example, the shell 20 has a minimum thickness of between about 0.5 millimetres and about 2 millimetres.

In some embodiments, for example, the material of the shell 20 has a modulus of elasticity of at least about 15×10⁶ psi, at standard ambient temperature and pressure (“SATP”) conditions (defined as a temperature of 25 degrees Celsius and a pressure of 1 bar), and is unreactive, or substantially unreactive with hydrochloric acid under wellbore conditions.

In some embodiments, for example, the material of the shell 20 has a tensile strength of at least about 50 ksi (50,000 psi), at SATP conditions.

In some embodiments, the material of the shell 20 includes metal-comprising material. In some of these embodiments, for example, the material of the shell 20 includes titanium, carbon steel, stainless steel, nickel alloy steel. In some of these embodiments, for example, the material of the shell 20 includes a superalloy. In some embodiments, for example, the material of the shell 20 consists, or substantially consists, of titanium. In some embodiments, for example, the material of the shell 20 consists or substantially consists of titanium and one or more alloys of titanium.

In some embodiments, for example, the inner core 30 is disposed within the shell 20. In some embodiments, for example the shell 20 surrounds the inner core 30. In some embodiments, for example, the shell 22 includes an interior surface 24, and the entirety, or the substantial entirety of the surface 24 is disposed in contact engagement with the inner core 30. In some embodiments, for example, there is no gap, or substantially no gap, between the inner core 30 and the shell 20. In some embodiments, for example, the inner core 30 fills, or substantially fills, the cavity defined by the shell 20.

In some embodiments, for example, the inner core 30 is exerting force on the shell 20 such that the shell 20 is subjected to stress and disposed in tension.

The material of the inner core 30 includes at least one polymeric material.

In some embodiments, for example, the polymeric material includes plastic material. Suitable plastic material include G10 plastic, laminated G10, polyether ether ketone (PEEK), or Vespel™.

In some embodiments, for example, the polymeric material includes at least one of natural rubber and synthetic rubber.

In some embodiments, for example, the inner core 30 includes a composite material, and the composite material includes microspheres. Suitable microspheres includes microbeads (polyethylene microspheres) and glass microspheres. Suitable glass microspheres include 3M™ Glass Bubbles iM16K and 3M™ Performance Additives iM30K. In some embodiments, for example, the microspheres have an average diameter from about 10 microns to about 50 microns. In some embodiments, for example, the composite material includes at least about 10 volume % microspheres, based on the total volume of the inner core 30, wherein the microspheres include at least one of microbeads and glass microspheres. In some embodiments, for example, the composite material includes between about 10 volume % microspheres, based on the total volume of the inner core 30, and about 50 volume % microspheres, based on the total volume of the inner core 30, wherein the microspheres include at least one of microbeads and glass microspheres. In some embodiments, for example, the composite material includes between about 20 volume % microspheres, based on the total volume of the inner core 30, and about 50 volume % microspheres, based on the total volume of the inner core 30, wherein the microspheres include at least one of microbeads and glass microspheres. In some embodiments, for example, the composite material includes between about 30 volume % microspheres, based on the total volume of the inner core 30, and about 50 volume % microspheres, based on the total volume of the inner core 30, wherein the microspheres include at least one of microbeads and glass microspheres. In some embodiments, for example, the composite material includes the polymeric material, and, in some of these embodiments, for example, the composite material includes at least about one (1) volume % polymeric material, based on the total volume of the inner core 30. In some embodiments, for example, the composite material includes the polymeric material, and, in some of these embodiments, for example, the composite material includes at least about 50 volume % polymeric material, based on the total volume of the inner core 30. In some embodiments, for example, the composite material includes the polymeric material, and, in some of these embodiments, for example, the composite material includes between about 50 volume % polymeric material, based on the total volume of the inner core 30, and about 70 volume % polymeric material, based on the total volume of the inner core 30.

The microsphere component of the inner core 30 assists in reducing weight of the inner core 30 and, therefore, the specific gravity of the fluid communication-interference body 10. In some of these embodiments, for example, the composite material of the inner core 30 further includes at least one of polymeric material (such as one or more of those enumerated above) and mud. In some embodiments, for example, the composite material includes: (i) at least one of polymeric material (such as one or more of those enumerated above) and mud, and (ii) microspheres, and the microspheres are distributed (such as, for example, uniformly distributed or substantially uniformly distributed) throughout the inner core. In some embodiments, for example, the composite material includes a matrix material, and the matrix material includes the at least one of polymeric material and mud, and the microspheres are impreganted within the matrix material.

In some embodiments, for example, the material of the inner core 30 has a minimum compressive strength of at least about 5 ksi (5,000 psi) at SATP, such as, for example, at least about 10 ksi at SATP, and such as, for example, at least about 15 ksi at SATP.

In some embodiments, for example, the fluid communication-interference body is a frac ball, and the frac ball has a diameter of between about one (1) inch and about five (5) inches, such as, for example, between about two (2) inches and about four (4) inches.

The specific gravity of the fluid communication-interference body 10 is less than about 1.8. In some embodiments, the specific gravity is about 1.0 or less. In some embodiments, the density of the fluid communication-interference body 10 is less than the density of the wellbore treatment fluid.

In some embodiments, the thermal expansion coefficient of the core material is greater than the thermal expansion coefficient of the shell material.

The fluid communication-interference body 10 can be produced by forming a hollow shell with at least one aperture, and then injecting the material of the inner core 30, or a precursor material to the material of the inner core 30 (such as in the case, for example, where the injected material cures, and thereby undergoes a reactive process such as at least a fraction of such injected material is converted to another material) through the aperture into the space within the shell to fill the space within the shell. In some implementations, the material is injected under pressure (such as greater than 10 psi). In some implementations, the injected material is configured to expand upon curing, and thereby exert stress on the shell 20. In some implementations, the shell is heated prior to the injecting, and the material is injected through the aperture to fill the space within the shell while the shell is in the heated state, such that, upon cooling of the shell, the plastic material core 30 exerts stress on the shell 20. The aperture can be filled with a pin (pin welded to seal aperture or press-fit into aperture) or can be welded shut to fill.

In some embodiments, for example, the opening within a well is an orifice 62 disposed within a seat 60, such as a valve seat. The seat 60 may be positioned within a conduit 42 that is disposed within a wellbore 40. The conduit 42 includes a fluid passage 44. The fluid passage 44 includes an uphole portion 44A and a downhole portion 44B. In some embodiments, for example, at least a portion of the conduit 42 is defined by casing 46, such as production casing. The wellbore 40 is formed within a subterranean formation 50.

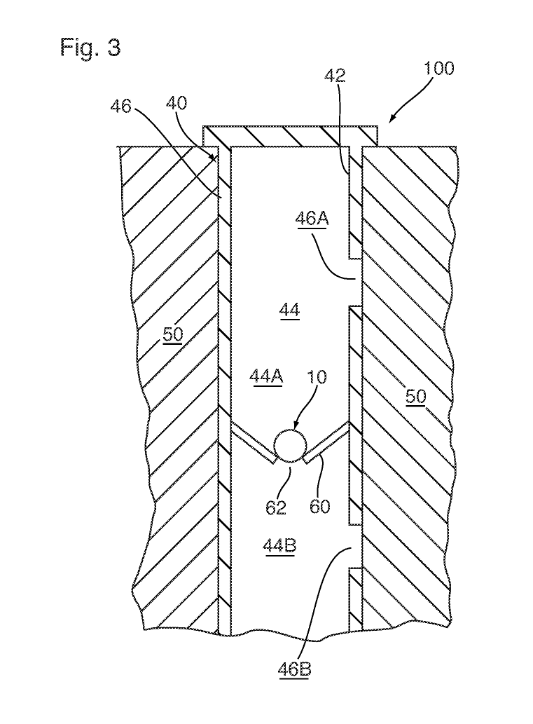

Referring to FIG. 3, the fluid communication-interference body 10 is configured for engaging and seating on the seat 60. The fluid communication-interference body 10 may be landed on the seat 10 by flowing the fluid communication-interference body 10 with hydraulic treatment fluid that is supplied to the fluid passage 44 of the conduit 42. Once landed, the seating of the fluid communication-interference body 10 with the seat 60 is such that the fluid communication-interference body 10 is interfering with fluid communication, across the seat 60, between the uphole portion 44A of the fluid passage 44 and the downhole portion 44B of the fluid passage 44.

In this respect, the seating of the fluid communication-interference body 10 on the seat 60, for which the fluid communication-interference body 10 is configured, is such that the fluid communication-interference body 10 interferes with flow of wellbore treatment fluid through the orifice and downhole relative to the seat 60. In some embodiments, for example, the interference is such that sealing, or substantial sealing, of fluid communication is effected, via the orifice 62, between the uphole portion 44A and the downhole portion 44B. In some embodiments, for example, the interference is such that zonal isolation is effected between the uphole portion 44A of the fluid passage 44 and the downhole portion 44B of the fluid passage 44.

In some of these embodiments, for example, such zonal isolation is desirable during a multi-stage hydraulic fracturing operation, and, in this respect, the above-described embodiment is illustrative of a hydraulic fracturing system 100 for implementing a multi-stage hydraulic fracturing operation.

In some embodiments, for example, the wellbore treatment fluid is a slurry, such as fraccing fluid, that includes proppant.

In some of these embodiments, for example, the seating of the fluid communication-interference body 10 on the seat 60, for which the fluid communication-interference body 10 is configured, is such that, while wellbore treatment slurry is being supplied from a source uphole of the seat 60 (such as, for example, a source at the surface) to the uphole portion 44A of the fluid passage 44, proppant, of the wellbore treatment slurry being supplied, is prevented, or substantially prevented, from being conducted past the fluid communication-interference body 10, through the orifice 62, and downhole relative to the seat 60. In some embodiments, the proppant has a diameter of about 0.034 inches (“20/40 proppant”). In some embodiments, the proppant is characterized by a size of 100 mesh.

In some embodiments, the fluid communication-interference body 10 and the seat 60 are co-operatively configured such that, when the fluid communication-interference body 10 is seated on the seat 60, and a pressure differential of greater than about 5,000 psi (such as, for example, greater than about 10,000 psi) is being applied across the seat 60 and effected by wellbore treatment slurry being supplied to the uphole portion 44A of the fluid passage 44 (i.e. the fluid passage portion that is immediately uphole relative to the seat 60), the proppant (such as, for example, the 20/40 proppant, or the proppant that is characterized by a size of 100 mesh) is prevented, or substantially prevented, from being conducted past the fluid communication-interference body 10, through the orifice 62, and downhole relative to the seat 60, for a period of time of at least one hour. In some embodiments, for example, the period of time that is sufficient to effect hydraulic fracturing, uphole of the seat 60, via an opening (such as a port) in the conduit 42. In this respect, during this time period, the fluid communication-interference body 10 does not extrude, or substantially extrude, into or through the orifice 62 of the seat 60, in response to the applied pressure differential, such that the above described prevention, or substantial prevention, of conduction of proppant, downhole relative to the seat 60 and past the fluid communication-interference body 10 through the orifice 62, while the fluid communication-interference body 10 is seated on the seat 60, thereby maintaining, or substantially maintaining, the desired zonal isolation.

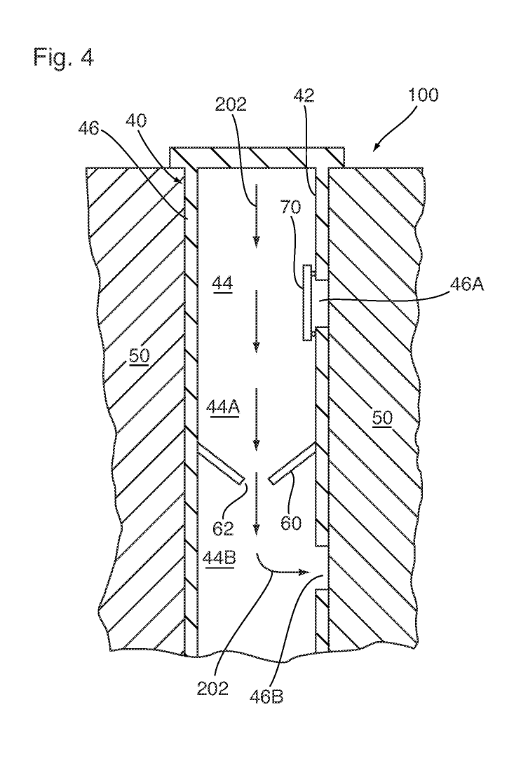

Referring to FIGS. 4 to 7, an embodiment of a process implementation, using the fluid communication-interference body 10 of the present disclosure, will now be described, in the context of the system 100 described above.

Referring to FIG. 4, hydraulic treatment fluid 202 is supplied, through the fluid passage 44 of the conduit 42, to the subterranean formation via a downhole formation-communicating port 46B disposed within the conduit. This effects supplying of hydraulic treatment fluid to the subterranean formation via the downhole formation-communicating port 46A. For example, this supplying may defines a first stage of the multi-stage hydraulic fracturing operation.

The port 46B may have been pre-defined within the conduit 42, prior to the conduit 42 being installed within the wellbore. As well, the port 46B, may have been, initially, in a closed condition, such that fluid communication, via the port 46B, between the wellbore and the subterranean formation, was being interfered with. In some of these embodiments, for example, the closed condition may have been effected by a sliding sleeve. In such case, in having the port 46B assume the open condition whereby fluid communication, via the port 46B, between the wellbore and the subterranean formation became effected, the sliding sleeve would be displaced. Alternatively, the port 46B may have been created by perforating with a perforating gun after the installation of the conduit 42 within the wellbore.

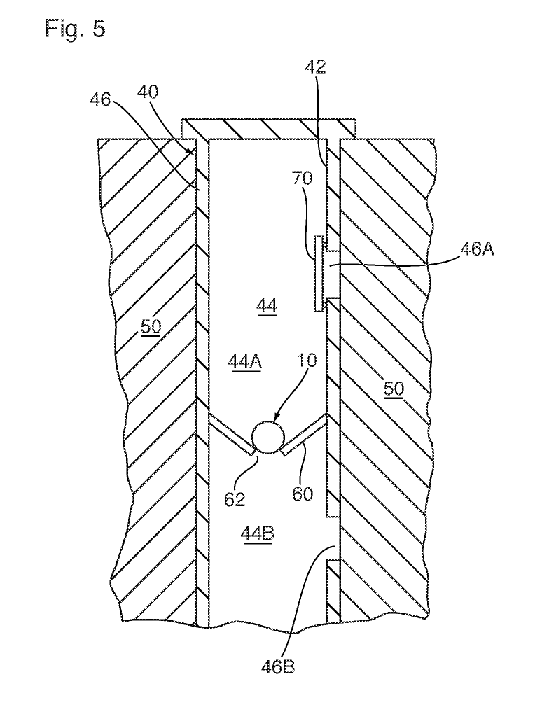

Referring to FIG. 5, after sufficient hydraulic treatment fluid has been supplied to the subterranean formation via the port 46B, the fluid communication-interference body 10 is flowed downhole through the fluid passage 44 such that the fluid communication-interference body becomes seated against a seat 60. By virtue of the seating of the fluid communication-interference body 10 on the seat 60, interference with fluid communication, across the seat 60, between the uphole portion 44A of the fluid passage 44 and the downhole portion 44B of the fluid passage 44 (including the port 46B), is effected. In some embodiments, for example, the fluid communication-interference body 10 may be flowed downhole with wellbore treatment fluid being supplied into the fluid passage 44 (in some of these embodiments, for example, the wellbore treatment fluid continues to be supplied from the time when the subterranean formation is being treated via port 46B to the time that the body is being deployed downhole). In some embodiments, for example, the interference is such that, while wellbore treatment slurry is being supplied from a source uphole of the seat 60 (such as, for example, a source at the surface) to the uphole portion 44A of the fluid passage 44, proppant (such as, for example, the 20/40 proppant), of the wellbore treatment slurry being supplied, is prevented, or substantially prevented, from being conducted past the fluid communication-interference body 10, through the orifice 62, and downhole relative to the seat 60. In some embodiments, for example, the interference is such that, while a pressure differential of greater than 5,000 psi (such as, for example, greater than 10,000 psi) is being applied across the seat 60 and effected by wellbore treatment slurry being supplied to the uphole portion 44A of the fluid passage 44 (i.e. the fluid passage portion that is immediately uphole relative to the seat 60), the proppant (such as, for example, the 20/40 proppant, or the proppant that is characterized by a size of 100 mesh) is prevented, or substantially prevented, from being conducted past the fluid communication-interference body 10, through the orifice 62, and downhole relative to the seat 60, for a period of time of at least one hour. In some embodiments, for example, the interference is such that zonal isolation is effected between upstream fluid passage portion 44A and the downstream fluid passage portion 44B.

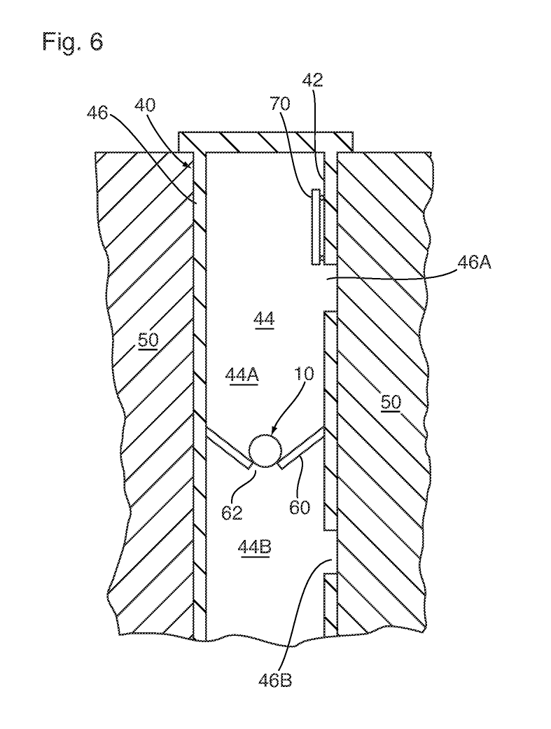

By virtue of this interference, pressurizing of the uphole portion 44A is enabled, and the pressurizing (such as, for example, by the supplying of the hydraulic treatment fluid) effects displacement of a valve 70 (such as a sliding sleeve) that is interfering with fluid communication, via an uphole formation communicating port 46A, between the wellbore and the subterranean formation (see FIG. 6). The port 46B is disposed uphole of the seating of the fluid communication-interference body 10 against the seat 60. The displacement effects a change in condition of the port 46A from a closed position to an open position, In the open position, fluid communication, via the port 46A, is being effected between the wellbore and the subterranean formation, such that, hydraulic treatment fluid being supplied downhole through the fluid passage 44 is conducted into the subterranean formation via the port 46A. In the closed position, the valve 70 is at least partially obscuring the port 46A such that interference is being effected to fluid communication, via the port, between the wellbore and the subterranean formation. In some embodiments, for example, the interference to the fluid communication includes sealing, or substantial sealing, of the fluid communication by the valve 70 (such as a sliding sleeve).

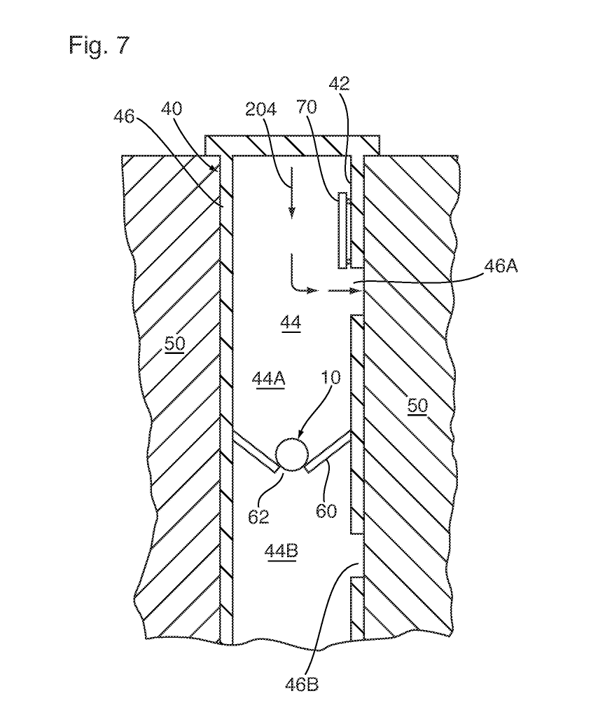

Referring to FIG. 7, hydraulic treatment fluid 204 is then supplied (or, in some of these embodiments where the fluid communication-interference body 10 is deployed downhole by being flowed with hydraulic treatment fluid, continues to be supplied) through the fluid passage 44 of the conduit 42 to the subterranean formation through the uphole formation-communicating port 46A, after the opening of the port 46A (and while the fluid communication-interference body 10 is seated on the seat 60). This effects supplying of hydraulic treatment fluid to the subterranean formation via the uphole formation-communicating port 46B. For example, this supplying may define a second stage of the multi-stage hydraulic fracturing operation.

One or more additional hydraulic fracturing stages may be implemented. After the desired number of stages have been completed, pressure within the fluid passage 44 is reduced (such as, for example, suspending the supplying of hydraulic treatment fluid and disposing the fluid passage 44 in fluid communication with a low pressure source (such as atmospheric pressure conditions within a tank), such that production of reservoir fluid is effected through the conduit, via the ports of the conduit (such as ports 46A, 46B). During this production, the fluid communication-interference body 10 (or bodies, where there are stages additional to the first and second stages described above) becomes displaced from the seat 60, and is flowed, with the produced reservoir fluid, uphole to above the surface.

In the above description, for purposes of explanation, numerous details are set forth in order to provide a thorough understanding of the present disclosure. However, it will be apparent to one skilled in the art that these specific details are not required in order to practice the present disclosure. Although certain dimensions and materials are described for implementing the disclosed example embodiments, other suitable dimensions and/or materials may be used within the scope of this disclosure. All such modifications and variations, including all suitable current and future changes in technology, are believed to be within the sphere and scope of the present disclosure. All references mentioned are hereby incorporated by reference in their entirety.

1. A fluid communication-interference body comprising:
a shell including a shell material having a modulus of elasticity of greater than 15 and a tensile strength of at least at least about 15×10⁶ psi, at SATP conditions, and a tensile strength of at least about 50 ksi, at SATP conditions; and
an inner core including an inner core material having a minimum compressive strength of at least about 5 ksi, at SATP conditions.

2. The fluid communication-interference body as claimed in claim 1;
wherein the shell material includes metal-comprising material;
and wherein the inner core material includes polymer-comprising material.

3. A fluid communication-interference body comprising:
a shell; and
an inner core including inner core material, wherein the inner core material includes microspheres.

4. The fluid communication-interference body as claimed in claim 3;
wherein the microspheres include microbeads

5. The fluid communication-interference body as claimed in claim 3;
wherein the microspheres include glass microspheres.

6. The fluid communication-interference body as claimed in claim 3;
the composite material includes at least about 10 volume % microspheres, based on the total volume of the inner core.

7. The fluid communication-interference body as claimed in claim 3; the composite material includes less than about 50 volume % microspheres, based on the total volume of the inner core.

8. The fluid communication-interference body as claimed in claim 3;
wherein the inner core material is composite material and further includes polymer-comprising material.

9. The fluid communication-interference body as claimed in claim 3;
the composite material includes at least about 50 volume % polymer-comprising material, based on the total volume of the inner core.

10. The fluid communication-interference body as claimed in claim 8;
wherein the composite material includes a matrix material, and the matrix material includes the polymer-comprising material, and the microspheres are distributed within the matrix material.

11. The fluid communication-interference body as claimed in claim 3;
wherein the shell material includes metal-comprising material

12. A fluid communication-interference body comprising:
a shell including metal-comprising material; and
an inner core including polymer-comprising material;
wherein the body is configured for engaging a seat disposed within a wellbore such that, when the fluid communication-interference body is seated against the seat while a pressure differential of greater than about 5,000 psi is being applied across the seat and effected by wellbore treatment fluid being supplied uphole relative to the seat, proppant of the wellbore treatment slurry is prevented, or substantially prevented, from being conducted past the fluid communication-interference body, through an orifice, and downhole relative to the seat.

13. The fluid communication-interference body as claimed in claim 12;
wherein the proppant has a diameter of about 0.034 inches.

14. The fluid communication-interference body as claimed in claim 12;
wherein the proppant is characterized by a size of 100 mesh.

15. (canceled)

16. (canceled)

17. The fluid communication-interference body as claimed in claim 1;
wherein the shell has a minimum thickness of at least about 0.5 millimetres.

18. The fluid communication-interference body as claimed in claim 1;
wherein the shell has a minimum thickness of less than about 2 millimetres

19. The fluid communication-interference body as claimed in claim 1, and further characterized by a diameter of between about one (1) and about five (5) inches.

20. (canceled)

21. (canceled)

22. The fluid communication-interference body as claimed in claim 1;
wherein the shell includes an interior surface, and the entirety, or the substantial entirety of the surface is disposed in contact engagement with the inner core.

23. (canceled)

24. The fluid communication-interference body as claimed in claim 1;
wherein the thermal expansion coefficient of the core material is greater than the thermal expansion coefficient of the shell material.

25.-35. (canceled)

36. The fluid communication-interference body as claimed in claim 3;
wherein the shell has a minimum thickness of at least about 0.5 millimetres.

37. The fluid communication-interference body as claimed in claim 3;
wherein the shell has a minimum thickness of less than about 2 millimetres

38. The fluid communication-interference body as claimed in claim 3, and further characterized by a diameter of between about one (1) and about five (5) inches.

39. The fluid communication-interference body as claimed in claim 3;
wherein the shell includes an interior surface, and the entirety, or the substantial entirety of the surface is disposed in contact engagement with the inner core.

40. The fluid communication-interference body as claimed in claim 3;
wherein the thermal expansion coefficient of the core material is greater than the thermal expansion coefficient of the shell material.

41. The fluid communication-interference body as claimed in claim 12;
wherein the shell has a minimum thickness of at least about 0.5 millimetres.

42. The fluid communication-interference body as claimed in claim 12;
wherein the shell has a minimum thickness of less than about 2 millimetres

43. The fluid communication-interference body as claimed in claim 12, and further characterized by a diameter of between about one (1) and about five (5) inches.

44. The fluid communication-interference body as claimed in claim 12;
wherein the shell includes an interior surface, and the entirety, or the substantial entirety of the surface is disposed in contact engagement with the inner core.

45. The fluid communication-interference body as claimed in claim 12;
wherein the thermal expansion coefficient of the core material is greater than the thermal expansion coefficient of the shell material.
